(19) United States
(12) Patent Application Publication
(10) Pub. No.: US 2014/0040009 A1
(43) Pub. Date: Feb. 6, 2014

(54) PROVIDING AND FILTERING KEYWORD STACKS

(71) Applicants: Yun SHI, Redmond, WA (US); Anand EDWIN, Bellevue, WA (US); Dong CHEN, Issaquah, WA (US); Safiya I. BHOJAWALA, Seattle, WA (US); Wai CHAN, Bellevue, WA (US); Sameer ABROL, Bellevue, WA (US); Haik E. BABAIAN, Issaquah, WA (US)

(72) Inventors: Yun SHI, Redmond, WA (US); Anand EDWIN, Bellevue, WA (US); Dong CHEN, Issaquah, WA (US); Safiya I. BHOJAWALA, Seattle, WA (US); Wai CHAN, Bellevue, WA (US); Sameer ABROL, Bellevue, WA (US); Haik E. BABAIAN, Issaquah, WA (US)

(73) Assignee: Microsoft Corporation, Redmond, WA (US)

(21) Appl. No.: 13/564,562

(22) Filed: Aug. 1, 2012

(51) Int. Cl. G06Q 30/02

(52) U.S. Cl. 705/14.42

(57) ABSTRACT

Computer-readable media, computer systems, and computing devices for providing and filtering keyword stacks are provided. In embodiments, the method includes receiving an indication to display a set of keyword stacks. Each of the keyword stacks is associated with a different internet advertising metric. Keyword data associated with each of the internet advertising metrics is referenced. Thereafter, the keyword data associated with each of the internet advertising metrics is utilized to generate each of the keyword stacks. In some cases, each of the keyword stacks includes a set of horizontal bars vertically stacked with each horizontal bar representing a number of keywords falling within a particular metric measurement, or range thereof, corresponding with a vertical axis.

### BACKGROUND

For online advertisers, advertising campaign performance information is vitally important. But displays of internet advertising metrics associated with an advertising campaign, or keywords associated therewith, are frequently limited to a textual or table format. Navigating such data to optimize keyword performance can be inefficient, time consuming, and even error prone. For example, users oftentimes obtain keyword data from a data table for keywords having one keyword per row. A typical advertiser may have 1500 keywords and, as such, will have 1500 data rows (approximately 50 pages) to decipher. Thus, it is difficult for the advertiser to gain a comprehensive view of how well, for example, a particular advertising keyword is performing relative to other keywords within an advertising campaign or an advertiser's advertising account.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things, generating and presenting a graphical user interface that allows a user to view one or more metrics related to a discrete subject matter and filter such metrics. This is useful across a broad spectrum of fields. For example, a person in the financial field would like to view multiple financial metrics at the same time such as cost, spend, return on investment, and the like. More specifically, embodiments of the present invention enable an advertiser to view one or more internet advertising metrics related to an advertising campaign in a corresponding keyword stack. Each keyword stack is associated with a particular metric and is a distribution graph of keywords on the corresponding metric. A user can interact with one or more represented keywords within the keyword stack to filter additional keyword stacks associated other metrics so that such keyword stacks visually distinguish or display the corresponding keyword representations. Implementing embodiments of the present invention enables an advertiser to efficiently and accurately analyze keywords within an advertising campaign or account such that the advertiser can easily identify high-impact keywords and thereby optimize his or her advertisements.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system suitable for generating a graphical user interface for displaying keyword stacks, in accordance with an embodiment of the present invention;

FIG. 3 illustrates an exemplary display of multiple keyword stacks presented in association with an advertising campaign, in accordance with an embodiment of the present invention;

FIG. 4 illustrates an exemplary display for selecting metrics for displaying keyword stacks, in accordance with an embodiment of the present invention;

FIG. 5 illustrates an exemplary display of a keyword stacks using a bar implementation, in accordance with an embodiment of the present invention;

FIG. 6 illustrates an exemplary display for filtering keywords within keyword stacks, in accordance with an embodiment of the present invention;

FIGS. 7A-7B illustrate another exemplary display for filtering keywords within keyword stacks, in accordance with an embodiment of the present invention;

FIG. 8 illustrates yet another exemplary display for filtering keywords within keyword stacks, in accordance with an embodiment of the present invention;

FIGS. 9A-9B illustrate exemplary displays for rescaling keyword stacks based on implemented filters, in accordance with an embodiment of the present invention;

FIGS. 10A-10B illustrate an exemplary display for filtering keyword stacks, in accordance with an embodiment of the present invention;

FIG. 11 illustrates an exemplary display for filtering a keyword grid based on filters applied to one or more keyword stacks, in accordance with an embodiment of the present invention;

FIG. 12 illustrates an exemplary display for a reset option, in accordance with an embodiment of the present invention;

FIGS. 13A-13B illustrate exemplary displays for selecting a predetermined filtering area, in accordance with an embodiment of the present invention;

FIG. 14 illustrates an exemplary display for providing a data bar associated with one or more keyword stacks, in accordance with an embodiment of the present invention;

FIGS. 15A-C illustrate exemplary displays for an implementation used when a particular number of zero values exist for a metric, in accordance with an embodiment of the present invention;

FIG. 16 illustrates an exemplary display of a dot keyword stack, in accordance with an embodiment of the present invention;

FIG. 17 illustrates an exemplary display of multiple dot keyword stack, in accordance with an embodiment of the present invention;

FIGS. 18A-18B illustrate exemplary displays of filtered keyword stacks, in accordance with an embodiment of the present invention;

FIGS. 19A-19C illustrate other exemplary displays of filtered keyword stacks, in accordance with an embodiment of the present invention;

FIGS. 20A-20B illustrate exemplary displays of keyword stacks using a period over period comparison, in accordance with an embodiment of the present invention;

FIGS. 21A-21B illustrate exemplary displays for sequentially plotting dots at the same level, in accordance with an embodiment of the present invention;

FIG. 22 illustrates an exemplary display for using a grey scale to reflect density for stack levels, in accordance with an embodiment of the present invention;

FIG. 23 illustrates an exemplary display for presenting more granular details of a section of a keyword stack, in accordance with an embodiment of the present invention;

FIG. 24 illustrates an exemplary display for presenting a keyword stack having a width to accommodate a single keyword representation;

FIG. 25 is a flow diagram illustrating a method for providing one or more keyword stacks, in accordance with an embodiment of the present invention; and

FIG. 26 is a flow diagram illustrating a method for filtering one or more keyword stacks, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, generating and presenting a graphical user interface that allows a user to view one or more metrics related to a discrete subject matter and filter such metrics. This is useful across a broad spectrum of fields. For example, a person in the financial field would like to view multiple financial metrics of stocks or bonds at the same time such as cost, spend, return on investment, and the like. More specifically, embodiments of the present invention enable an advertiser to view one or more internet advertising metrics of keywords related to an advertising campaign in a corresponding keyword stack. Each keyword stack is associated with a particular metric and is a distribution graph of keywords on the corresponding metric. A user can interact with one or more represented keywords within the keyword stack to filter additional keyword stacks associated other metrics so that such keyword stacks visually distinguish or display the corresponding keyword representations. Implementing embodiments of the present invention enables an advertiser to efficiently and accurately analyze keywords within an advertising campaign or account such that the advertiser can easily identify high-impact keywords and thereby optimize his or her advertisements.

Accordingly, in one embodiment, the present invention is directed toward a graphical user interface for displaying keyword stacks, stored on one or more computer-readable media and executable by a computing device. The graphical user interface includes a keyword-stack display area configured to display one or more keyword stacks, each of the one or more keyword stacks associated with an internet advertising metric, wherein each keyword stack displays a keyword representation for each keyword within an advertising campaign with the keyword representation being vertically positioned in association with a corresponding value for the metric. The graphical user interface also includes a keyword grid display area configured to display a table of keywords and corresponding metric values for a plurality of metrics.

In another embodiment, the present invention is directed toward a computerized method. The computerized method includes receiving an indication to display a set of keyword stacks, each of the keyword stacks being associated with a different internet advertising metric. Keyword data associated with each of the internet advertising metrics is referenced. The keyword data associated with each of the internet advertising metrics are used to generate each of the keyword stacks. Each of the keyword stacks includes a plurality of horizontal bars vertically stacked with each horizontal bar representing a number of keywords falling within a particular metric measurement, or range thereof, corresponding with a vertical axis.

In yet another embodiment, the present invention is directed to one or more computer-readable storage media. The method includes presenting a first keyword stack and a second keyword stack. The first keyword stack and the second keyword stack are associated with a different keyword metric that indicates performance of keywords. Further, the first keyword stack and the second keyword stack include a representation of each keyword within an advertising campaign or an advertising account. Thereafter, an indication of a selection of a set of one or more keyword representations within the first keyword stack is received. Based on the selection, keyword representations within the second keyword stack are automatically filtered such that keyword representations within the second keyword stack that correspond with the selected one or more keyword representations within the first keyword stack are visually distinguished.

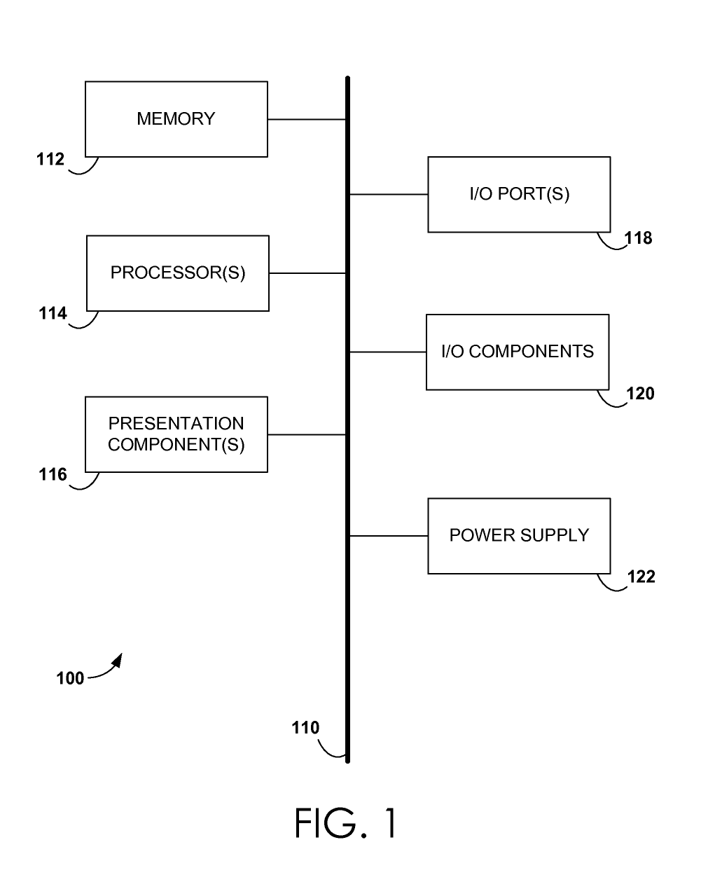

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a set of one or more processes distributed on one or more computers, one or more stand-alone storage devices, a set of one or more other computing or storage devices, a combination of one or more of the above, and the like.

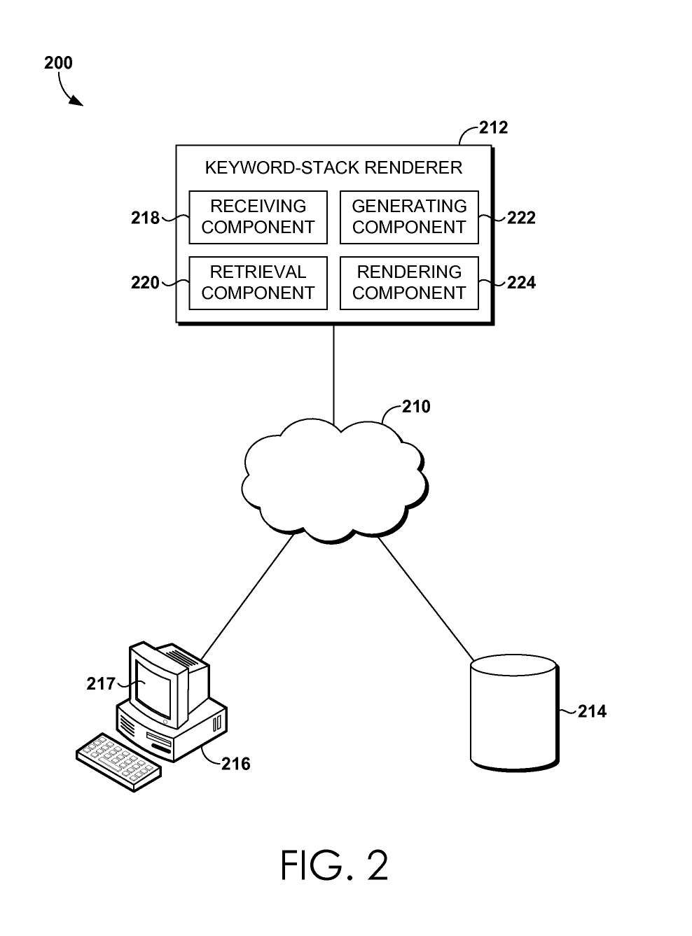

Turning now to FIG. 2, a block diagram is illustrated that shows an exemplary computing system environment 200 suitable for use in implementing embodiments of the present invention. It will be understood and appreciated that the computing system environment 200 shown in FIG. 2 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a keyword-stack renderer 212, a data store 214, and an end-user computing device 216 with a display screen 217 all in communication with one another via a network 210. The network 210 may include, without limitation, one or more local area networks (LANs) and/or wide area networks (WANs). Such networking environments are commonplace in offices, enterprise-wide computer networks, intranets and the Internet. Accordingly, the network 210 is not further described herein.

In some embodiments, one or more of the illustrated components/modules may be implemented as stand-alone applications. In other embodiments, one or more of the illustrated components/modules may be integrated directly into the operating system of the keyword-stack renderer 212. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers, search engine computing devices, or the like. By way of example only, the keyword-stack renderer 212 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 214 is configured to store information associated with internet advertising. In various embodiments, such information may include, without limitation, information concerning internet advertisers and their internet advertisement campaigns, internet advertising metrics associated with the advertisement campaigns, information on advertisement industry benchmarks, internet search engines, and/or the like. In embodiments, the data store 214 is configured to be searchable for one or more of the items stored in association therewith. The information stored in association with the data store 214 may be configurable and may include any information relevant to advertisers, advertisement campaigns, internet advertising metrics, internet search engines, and/or the like. The content and volume of such information are not intended to limit the scope of embodiments of the present invention in any way. Further, though illustrated as a single, independent component, the data store 214 may, in fact, be a plurality of storage devices, for instance, a database cluster, portions of which may reside on the keyword-stack renderer 212, end-user computing device 216, and/or any combination thereof.

As shown, the end-user computing device 216 includes a display screen 217. The display screen 217 is configured to display information to the user of the end-user computing device 216, for instance, information relevant to communications initiated by and/or received by the end-user computing device 216, information concerning internet advertising metrics, graphical displays of internet advertising metrics, and/or the like. Embodiments are not intended to be limited to visual display but rather may also include audio presentation, combined audio/visual presentation, and the like. The end-user computing device 216 may be any type of display device suitable for presenting a GUI. Such computing devices may include, without limitation, a computer, such as, for example, computing device 100 described above with reference to FIG. 1. Other types of display devices may include tablet PCs, PDAs, mobile phones, smart phones, as well as conventional display devices such as televisions.

The keyword-stack renderer 212 shown in FIG. 2, as described more fully below, may be any type of computing device, such as, for example, computing device 100 described above with reference to FIG. 1. By way of example only and not limitation, the keyword-stack renderer 212 may be a personal computer, desktop computer, laptop computer, handheld device, mobile handset, consumer electronic device, a server, a cluster of servers, or the like. It should be noted, however, that embodiments are not limited to implementation on such computing devices, but may be implemented on any of a variety of different types of computing devices within the scope of embodiments hereof.

Components of the keyword-stack renderer 212 may include, without limitation, a processing unit, internal system memory, and a suitable system bus for coupling various system components, including one or more data stores for storing information (e.g., files and metadata associated therewith). The keyword-stack renderer 212 typically includes, or has access to, a variety of computer-readable media. By way of example, and not limitation, computer-readable media may include computer-storage media and communication media. The computing system environment 200 is merely exemplary. While the keyword-stack renderer 212 is illustrated as a single unit, one skilled in the art will appreciate that the keyword-stack renderer 212 is scalable. For example, the keyword-stack renderer 212 may in actuality include a plurality of computing devices in communication with one another. Moreover, the data store 214, or portions thereof, may be included within, for instance, the keyword-stack renderer 212, a search engine, or a third-party service as a computer-storage medium. The single unit depictions are meant for clarity, not to limit the scope of embodiments in any form.

As shown in FIG. 2, the keyword-stack renderer 212 comprises a receiving component 218, a retrieval component 220, a generating component 222, and a rendering component 224. In some embodiments, one or more of the components 218, 220, 222, and 224 may be implemented as stand-alone applications. In other embodiments, one or more of the components 218, 220, 222, and 224 may be integrated directly into the operating system of a computing device such as the computing device 100 of FIG. 1. It will be understood by those of ordinary skill in the art that the components 218, 220, 222, and 224 illustrated in FIG. 2 are exemplary in nature and in number and should not be construed as limiting. Any number of components may be employed to achieve the desired functionality within the scope of embodiments hereof.

The receiving component 218 is configured to receive (via the network 210) requests from a user (typically an advertiser) for a graphical representation(s) of internet advertising metrics associated with, for example, a particular advertising campaign or an advertising account associated with the advertiser. In embodiments, such a request from a user device may be specifically initiated by a user. For instance, a user may specify to view one or more metrics associated with an advertising campaign or an advertising account (e.g., an advertiser may have multiple advertising campaigns within his or her advertising account). In other embodiments, such a request from a user device may be provided based on a user selecting to generally view data associated with an advertisement campaign or an advertisement account. By way of example only, upon logging into a user's advertisement account, the user may select a tab, icon, or other indicator to view data pertaining to a campaign, advertisements, keywords, advertisement groups, or the like.

The receiving component 218 may also receive other user requests regarding the graphical representations. For example, the user may request to view a keyword stack associated with a particular metric or metrics. In this regard, the user may select to view one or more metrics. In one embodiment, a menu (e.g., drop down menu) may be used for each keyword-stack to allow the user to configure which metric the user would like to be displayed on the keyword stack. Such metric options may include, for example, average position, clicks (e.g., number of clicks), cost per action (CPA), cost per click (CPC), click through rate (CTR), conversions (e.g., number of conversions), conversion rate, impressions (e.g., number of impressions), and spend (e.g., amount of money spent or cost). In embodiments, such metric options can be selected at any time. For example, several metrics might be selected during account initialization, or thereafter, and saved such that the advertiser views keyword stacks associated with the selected metrics each instance the advertiser views the account, or a portion thereof. In another example, the metrics might be selected each instance the user wishes to view the keyword stack associated with the particular metric.

Further, a user may request that certain filters be applied to the internet advertising metrics. In this way, for a particular keyword-stack, a user can select to narrow the focus of a set of one or more specific keyword representations. Such a filter selection can be applied in any manner. In one embodiment, a menu (e.g., drop down menu) or set of links may be used for each keyword-stack to allow the user to select or filter which keyword or set of keywords the user would like to be displayed or visually distinguished (e.g., high-light, low-light, color variance, etc.) within the keyword stack. Such filter options may include, for example, all performing keywords, most expensive keywords (e.g., top 25% CPC), best performing keywords (e.g., top 25% clicks, bottom 25% CPC), keywords with zero clicks, low-impact keywords (e.g., top 10% CPC, bottom 10% clicks, bottom 10% CTR), etc. As can be appreciated, any number or substance of predetermined filters may be provided to advertisers as an option and/or selected by users. Further, in some cases, a user may generate filter options based on the advertiser's own preference such that the advertiser can simply select a desired filter for a particular keyword stack. In some cases, a filter option can be applied to multiple keyword stacks. For instance, assume that a user selects a “best performing keywords” filter option. In such a case, both a “click” keyword stack and a “CPC” keyword stack might be filtered.

In addition to or in the alternative of being able to select predetermined filters, a user can dynamically apply filters to apply to the internet advertising metrics. For instance, a user may select one or more keyword representations within a keyword stack associated with a particular metric. For instance, in a dot implementation that has a dot (or other symbol or icon) representing each keyword, a specific dot or set of dots can be selected by the user within a keyword stack. In a bar implementation that has a bar or line representing a set of keywords, a specific bar can be selected by the user within a keyword stack (e.g., by selecting a particular bar or using a slider to select one or more bars). As described more fully below, in a multi-stack presentation, when a user selects to filter a first keyword stack by selecting one or more keyword representations, one or more other keyword stacks may automatically filter the keyword representations to display the keyword representations that correspond with the keywords selected by the user in the first keyword stack.

Such filter options can be selected at any time. For example, several filters might be selected during account initialization, or thereafter, and saved such that the advertiser views keyword stacks displaying or visually distinguishing keywords associated with the selected filter each instance the advertiser views the account, or a portion thereof. In another example, the filters might be selected each instance the user wishes to view or filter the keyword stack associated with the particular metric.

The receiving component 218 may also receive requests from users that the internet advertising metrics be sampled over a specified range of time. For example, the user may request that the advertising metrics be sampled only for today, yesterday, the last 7 days, the last 14 days, the last 30 days, month to date, last month, last 3 months, or the last 6 months. Continuing, the receiving component 218 may also receive requests from users that graphical representations of additional internet advertising metrics be displayed. Any and all such variations, and any combination thereof, are contemplated to be within the scope of embodiments of the present invention.

The retrieval component 220 is configured to retrieve data associated with requested internet advertising metrics. The retrieval component may, for example, retrieve the internet advertising metrics, or data associated therewith, from the data store 214. Internet advertising metrics include a variety of well-known metrics that measure the effectiveness of an internet advertisement campaign. For example, internet advertising metrics may include impressions, clicks, spend, conversions, average position, average cost per click, click through rate, cost per action, cost per click, conversion rate, percentage of change, and the like. There are many examples of metrics used to measure the effectiveness of internet advertising and these are all included within the scope of the invention. Further, as the metrics may be displayed in association with a particular period of time, the retrieval component 220 can be configured to retrieve metric data associated with a particular time period (e.g., today, yesterday, the last 7 days, the last 14 days, the last 30 days, month to date, last month, last 3 months, or the last 6 months).

The generating component 222 is configured to generate or modify one or more keyword stacks. The one or more keyword stacks to generate or modify can be based on, for example, a default selection of metrics to be associated with keyword stacks (e.g., based on an application default, based on an advertiser's default preference, etc.) or a selection of a metric(s) while viewing an advertising campaign. Keyword stacks are generated in accordance with a particular metric or metrics, for example, as specified by a user or as set by a default setting or preference (e.g., system defined or user defined). As described more fully below, keyword stacks can be generated in any number of forms, such as a dot representation, a bar representation, various forms thereof, and the like. Any and all such variations, and any combination thereof, are contemplated to be within the scope of embodiments of the present invention.

Generally, a keyword stack associated with a particular metric is used to enable a user to visualize the keyword distribution in association with the specific metric. The keyword stack can show all the keyword representations for a particular advertisement campaign or advertisement account. The vertical component or axis of the keyword stack represents a metric measurement associated with keywords. Such a metric measurement may be any quantity or quality that can represent or indicate data pertaining to the keyword. For instance, a metric measurement may be a number, percent, ratio, etc. By way of example only, for a click keyword stack, the vertical scale can be a keyword's number of clicks for a specified time period. As such, the higher the position of a keyword, the larger the number of associated clicks.

In a dot implementation of a keyword stack, each dot represents a keyword. Each of the dots together provide a visual of the keyword distribution for clicks. Accordingly, top and/or bottom performers can visually stand out to the user without performing detailed analysis. Although the dot representation is generally described herein using dots, any shape, symbol, icon, or other representation can be utilized.

In a bar implementation of a keyword stack, each bar represents a number of keywords falling within a particular metric measurement, or range thereof. The longer or wider the bar, the more keywords that fall into that metric measurement or range. Utilizing bars can enhance scalability so that the visual bar can represent thousands of keywords. Further, the horizontal bars can be center-aligned, left-aligned or right-aligned. Center-aligned horizontal bars in a keyword stack collectively outline a symmetrical shape, such as a pyramid, a diamond, etc. that help the user visualize the overall distribution of the keywords.

The generating component 222 can further utilize any filters to generate and/or modify a keyword stack(s). That is, upon identifying a filter to apply to a particular keyword stack(s), the generating component 222 can generate a new keyword stack or modify a stack to display or visually distinguish any keyword representations associated with the applicable filter. For example, upon a user selecting a particular filter option for a keyword stack or set of keyword stacks (e.g., all performing keywords, most expensive keywords, best performing keywords, keywords with zero clicks, low-impact keywords), the keyword stack can be generated or modified accordingly. In another example, upon a user selecting one or more keyword representations within a keyword stack (e.g., a dot(s) or a bar(s)), the keyword stack can be generated or modified accordingly.

Further, the generating component 222 can also identify additional keyword stacks to generate or modify based on a filter applied to a particular keyword stack. For instance, assume that a user selects three keyword representations within a keyword stack (e.g., as each keyword appears to be performing exceptionally high or low relative to the other keywords). In such a case, the generating component 222 can identify other keyword stacks to modify (e.g., each additional presented keyword stack) and modify such stacks to display or visually distinguish the three corresponding keyword representations.

The rendering component 224 is configured to render a GUI that displays graphical representations of internet advertising metrics, for instance, in the same viewable area. In one aspect, the rendering component 224 utilizes information from the receiving component 218, the retrieval component 220, and/or the generating component 222 to generate a GUI uniquely tailored to the needs of a user. In another aspect, the rendering component 224 determines the amount of screen real estate available on a display device and resizes the graphical representations so that they effectively occupy the available screen space and are all visible within the same viewable area. In other words, it may not be necessary to use a browser scroll bar to view all of the graphical representations.

In yet another aspect, the rendering component 224 may determine that the screen width of a display device has changed. For example, a user may have switched from viewing the display screen of a personal computer to viewing the display screen of a smart phone. Upon making such a determination, the rendering component 224 may proportionally change the size of the graphical representations so that all of the representations continue to be in the same viewable area.

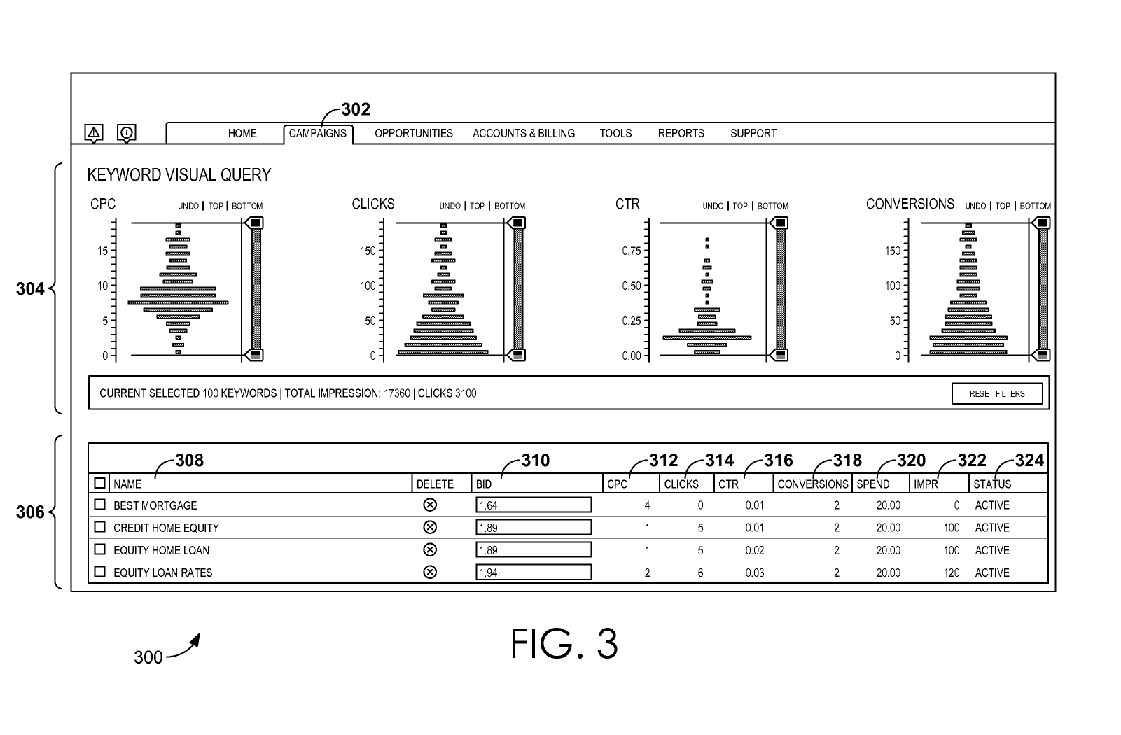

Turning now to FIGS. 3-24, graphical user interfaces (GUIs) or displays for displaying keyword stacks related to a plurality of internet advertising metrics are depicted. It should be understood that the graphical user interfaces or displays described herein are exemplary only and may differ in appearance, content, or configuration in various embodiments. Further, various selection portions can be used to navigate the display and those described herein are not meant to limit the scope of embodiments of the present invention. For instance, a user may interact with a button, a pull-down menu, a check box, a link (e.g., hypertext link), a click box, etc. to select, navigate, access, display, or the like. The displays can be accessed or navigated using any known input device. By way of example only, a keyboard, computer mouse, stylus, finger, voice, or any other selection component can be used to navigate or input data.

Initially, with reference to FIG. 3, FIG. 3, referenced generally by the numeral 300, illustrates an exemplary display of multiple keyword stacks presented in association with an advertisement campaign. As depicted in FIG. 3, a user can select to view data associated with an advertisement campaign by selecting the campaign tab 302. As can be appreciated, any number or format of icons can be selected to view keyword stacks. For example, in some cases, when a user clicks on a keyword subtab, one or more keyword stacks will be automatically presented. In one embodiment, the keyword stacks can be placed under an “Account Performance Trend” tab. A user can have the option to open both tabs at the same time enabling simultaneous viewing of account performance trends and keyword stacks, or can view either the account performance trends or the keyword stacks independent from one another. In one implementation, a user can toggle between the keyword stacks and the account performance trends, for instance, via a drop down menu.

As illustrated in FIG. 3, upon selecting the campaign tab 302 or other indicator to view data associated with keywords or keyword stacks, a stack displaying area 304 can be displayed that displays one or more keyword stacks in the same viewable area. In FIG. 3, the stack displaying area 304 provides four keyword stacks, each representing keyword distribution for four different metrics (e.g., out of eight possible metrics). In this exemplary embodiment, the keyword stacks are bar keyword stacks having keywords grouped into 25 sets or groups based on a value for each metric. Each keyword stack represents all the keywords with the corresponding values within each value range for the metric along the vertical axis enabling a user to quickly analyze performance of keywords in an ad campaign. Although FIG. 3 illustrates four keyword stacks, any number of keyword stacks can be displayed in the stack displaying area 304. Further, the selection of the specific keyword stacks to display can be obtained in any manner, for instance, based on an application default, a user default, a user selection, etc.

The stack displaying area 304 is displayed above a keyword grid display area 306. The keyword grid display area 306 includes a listing of the keywords within the advertising campaign or advertising account along with performance data associated with the keyword. For example, each keyword, or identifier thereof, is presented in column 308 with a corresponding bid 310, CPC 312, clicks 314, CTR 316, conversions 318, spend 320, impressions 322, and status 324. Accordingly, specific metric values associated with each keyword can be presented in the keyword grid display area 306. Although FIG. 3 illustrates the keyword stack(s) being displayed above the keyword grid display area 306, any arrangement of display areas is considered to be within the scope of embodiments of the invention. For instance, the keyword stacks could be positioned below or next to the keyword grid display area, the keyword stacks could be displayed on a page that is separate from a page on which the keyword grid is displayed, etc.

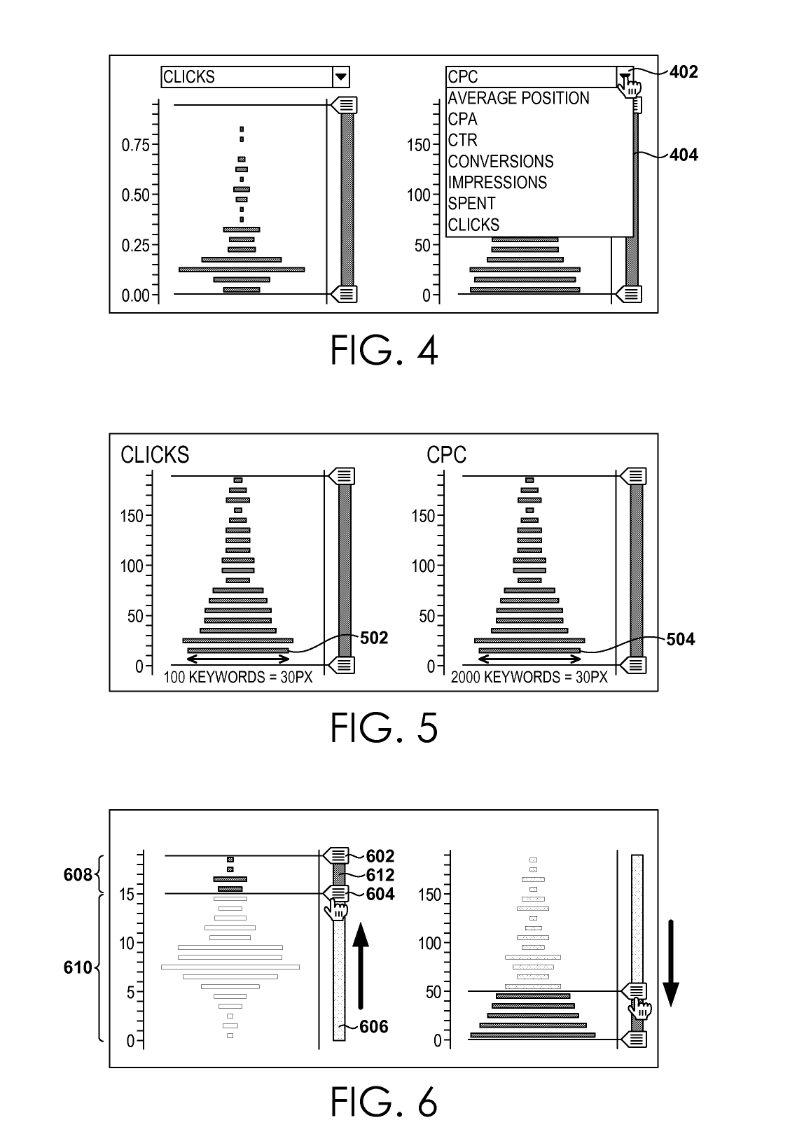

FIG. 4 illustrates a user interface enabling selection of metrics for displaying keyword stacks. In FIG. 4, a user can select a menu indicator 402 to provide an indication of a particular metric for which a keyword stack is desired. For instance, upon selecting the menu indicator 402, the user can be provided with a drop down menu 404 in FIG. 4 that includes metric options, such as, for example, CPC, average position, CPA, CTR, conversions, impressions, spent, and clicks.

In embodiments, a drop-down menu can be accessed for each keyword stack to allow the user to configure which metrics to view in association with the keywords. Although illustrated with eight metric options, any number of metrics can be provided. In some cases, if a user selects a new metric for which to display a keyword stack when one or more filters are already set for the chart, the filters may be reset. To maintain filters set by the user for other keyword stacks, such settings for those stacks may not be reset.

FIG. 5 illustrates exemplary keyword stacks using a bar implementation. As previously mentioned, each bar represents a number of keywords falling within a particular metric measurement, or range thereof. The longer or wider the bar, the more keywords that fall into that metric measurement or range. Utilizing bars can enhance scalability so that the visual bar can represent thousands of keywords. In this way, the stack data is scaled by grouping keywords into stacks based on the corresponding value for each metric. For example, a keyword with five clicks will fall into a category or value range containing keywords with zero to ten clicks. Similarly, a keyword with eight clicks will fall into the same value range.

In embodiments, there is no horizontal scale such that the length of each bar does not represent a specific number of keywords. For example, FIG. 5 illustrates two keyword stacks void of horizontal scaling. That is, a bar of a particular length in one keyword stack might represent a first number of keywords while a bar the same length in another keyword stack might represent a second number of keywords. For instance, bar 502 is a length of 30 pixels and represents 100 keywords while bar 504 also 30 pixels in length represents 2000 keywords. Such a scalability feature allows for the keyword stack to be applicable and usable for both a data set, for example, of only 10 keywords and a data set of 10,000 keywords.

As previously described, keyword stacks can be filtered in a number of manners. FIG. 6 illustrates one embodiment for filtering keywords within a keyword stack. FIG. 6 illustrates a first slider 602 and a second slider 604 that can be slid or moved along a sliding axis 606 to filter or narrow the selection of keywords of interest. As illustrated in FIG. 6, the first slider 602 and the second slider 604 are positioned such that the top four rows within the keyword stack are selected. Based on the applied filter, the selected rows can be displayed or visually distinguished to visually indicate or make apparent the selected or specified rows of interest. As shown in FIG. 6, the set of bars 608 are visually highlighted as compared to the set of bars 610. Such a highlighting can be performed in any manner. For instance, the highlighted bars may maintain their color or shade while the unselected bars are dimmed or faded in color or transparency. In other cases, the highlighted bars may be a bold font or displayed in a different color, etc.

In embodiments, each keyword stack includes two sliders to allow a user to filter the keyword data according to the user interests. The sliders can be moved up or down. In some cases, the other keyword stacks displayed can be automatically adjusted to reflect the new filter without the need for the user to click on an “apply” button.

Further, in some implementations, a user may select the area 612 between the first slider 602 and the second slider 604 along the sliding axis 606 to move the sliders while maintaining the distance between sliders. That is, the user can click within the area 612 in between the sliders and drag that section anywhere along the sliding axis 606 to modify the selected bars while preserving the distance between the sliders.

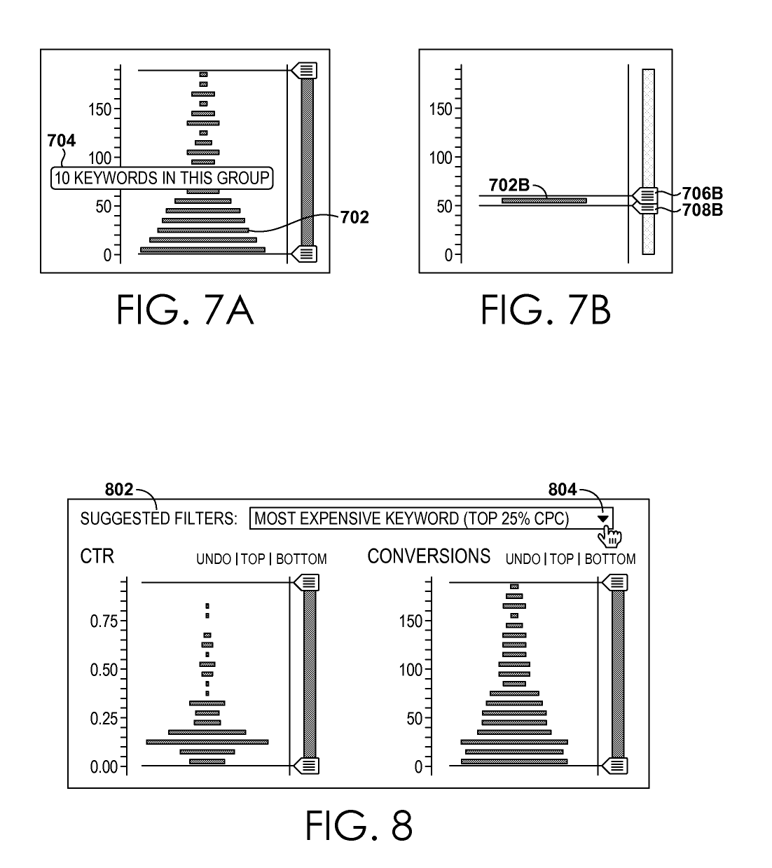

FIGS. 7A-7B illustrate a second embodiment for filtering keywords within a keyword stack. As illustrated in FIG. 7A, a user can select a horizontal bar representing a group of keywords to filter the keyword data. In some cases, when a user hovers over a particular horizontal bar 702, a tooltip 704 will provide data regarding the bar, such as the number of keywords in the selected group for that metric. Such data can provide the user with the size of the bucket so that the advertiser can have a better visualization or understanding of the overall keyword distribution. When the user selects or clicks on the horizontal bar 702, the bar 702B is selected and solely displayed or visually highlighted, as illustrated in FIG. 7B. In such a case, the sliders 706B and 708B can be automatically adjusted in accordance with the selection of the horizontal bar 702B. Further, all other data can be filtered out or visually impacted to indicate filtered results.

In yet a third embodiment for filtering keywords within a keyword stack, FIG. 8 illustrates filtering data based on a user selection of text data or a link. Optional filters 802 may include any number or makeup of filters including, for instance, all performing keywords, most expensive keywords, best performing keywords, keywords with zero clicks, low-impact keywords, etc. A filter can be selected via selection of an option presented within a drop-down menu 804. Upon a user selecting a predetermined optional filter, one or more of the keyword stacks are modified or generated to illustrate the selected data. Filtering the keywords may result in only those associated with the applied filter being displayed. For example, if the most expensive keyword filter is selected, only the keywords categorized as the most expensive keywords are displayed. In an alternative embodiment, filtering the keywords may result in a visual emphasis being placed on the keywords associated with the selected filter category. For instance, while a representation of each keyword may be graphically displayed, only the keywords falling within the selected filter category may be visually distinguished or set apart from the other keyword representations.

As can be appreciated, in some embodiments, filter options may be applicable to a single keyword stack. In other embodiments, filter options may be applicable to multiple keyword stacks. A user may have an option to save selected filter(s) such that the saved filter(s) can be applied at a later time.

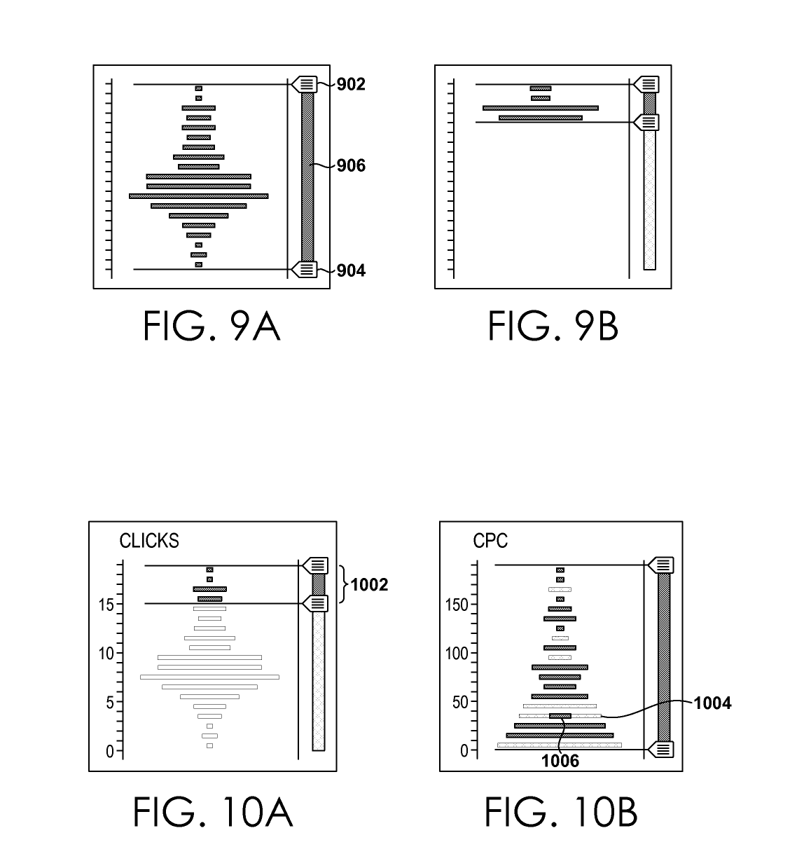

As illustrated in FIGS. 9A-9B, in one implementation, a keyword stack can automatically rescale as filters are implemented for the keyword stack. For example, as a user moves the sliders 902 and 904 along with the sliding axis 906 in FIG. 9A, the keyword stack can automatically rescale to more appropriately fit the horizontal space, as illustrated in FIG. 9B.

In filtering or interacting with keyword representations, various functions may occur in response to such filtering or user interaction. For example, as previously discussed and as illustrated in FIGS. 10A-10B, as a keyword stack associated with a particular metric is filtered to display or generally highlight a specific set of keyword representations, one or more other keyword stacks are accordingly filtered to display or generally highlight the corresponding keyword representations. That is, keyword stacks for other metrics will automatically adjust to the filter applied to one keyword stack. Accordingly, assume that a user selects keyword representations in a click keyword stack associated with region 1002 of FIG. 10A. In accordance with such a selection, the CPC keyword stack is modified to visually distinguish keyword representations that correspond with the selected keyword representations in the clicks keyword stack, as illustrated in FIG. 10B. Such an implementation may result in two series of data. A first series 1004 can represent the original unfiltered data which will have a lighter shade. A second series 1006 can represent the filtered data with a darker shade. The total length of each row can remain the same, with only the length of the first series and second series being changed as data is filtered.

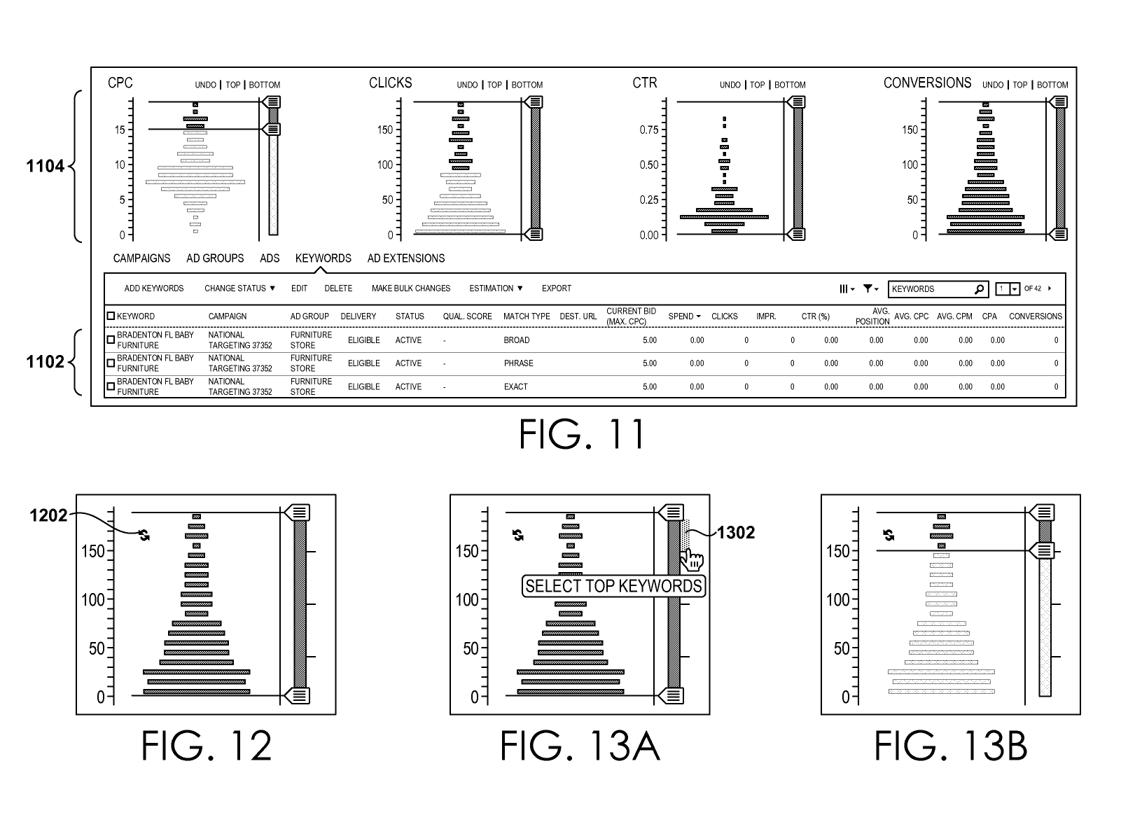

In addition to or in the alternative of filtering additional keyword stacks when a filter is applied to a particular keyword stack, as data is filtered within a keyword stack(s), the keyword grid can be automatically and dynamically adjusted to reflect the filtered keywords (e.g., filtered by filtered option selection, user selection of a bar, etc). Accordingly, changes made to a keyword stack can be reflected on the keyword grid by filtering the keywords, for instance, with the high CPC and low conversions. Accordingly, a user is able to quickly identify and/or analyze the low-impact keywords reflected on the grid. In some cases, the filtered-out keywords and corresponding data can be removed from the chart, moved to the bottom of the chart, or otherwise visually distinguished (e.g., faded, high-lighted, low-lighted, etc.). For example, as illustrated in FIG. 11, the keyword grid 1102 may be filtered in accordance with any filter or multiple filters applied to one or more keyword stacks provided in the keyword stack display area 1104.

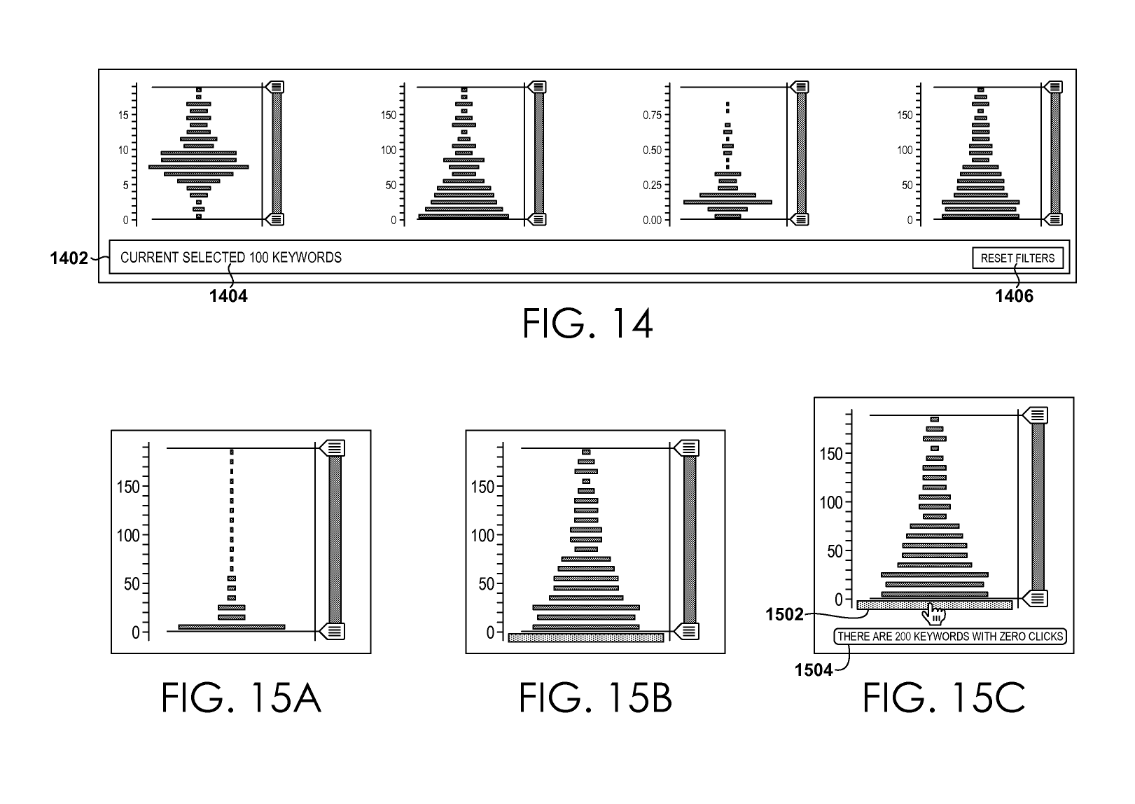

FIGS. 12-15 illustrate additional implementations that can be utilized in accordance with embodiments of the present invention. FIG. 12 illustrates a reset option 1202. The reset option 1202 can be any icon that, if selected, resets the sliders to the default state, such as the top and bottom of the sliding axis. FIG. 13 illustrates an option to select a predetermined area for filtering the keyword representations. Markers can be placed on a side of the sliding axis to divide the stack into various sections, such as equally spaced sections. A user can then hover over an area between the markers to view a clickable area 1302 as illustrated in FIG. 13A. Upon selecting the clickable area 1302, the keyword stack can be filtered accordingly, as illustrated in FIG. 13B. FIG. 14 illustrates a data bar 1402 displayed, for instance, along the bottom of the keyword stacks, to display the number of keywords 1404 currently selected as the user adjusts the sliders to filter out keywords and/or to display a general reset button 1406 to reset all the keyword stacks. A data bar can include any type and amount of data pertaining to keyword stacks.

FIG. 15 illustrates an implementation that can be used when a particular number of zero values exist for a metric. When a large amount of zero values for a metric exist, the keyword stack can be rescaled to result in a shape that is difficult for a user to analyze, as illustrated in FIG. 15A. Accordingly, the keyword stacks may ignore the zero values and scale the rest of the keywords. In one embodiment, a zero bar can be positioned to take up horizontal space at a zero position and may be visually distinguished. Such a zero bar can represent all keywords with a zero value. The remainder of the keyword stack can scale such that the stack with the most keywords will be a percent (e.g., 20%) shorter than the zero value bar, as shown in FIG. 15B. If a user hovers over the zero bar 1502, a tooltip 1504 of FIG. 15C can inform the user that there are N keywords with zero values.

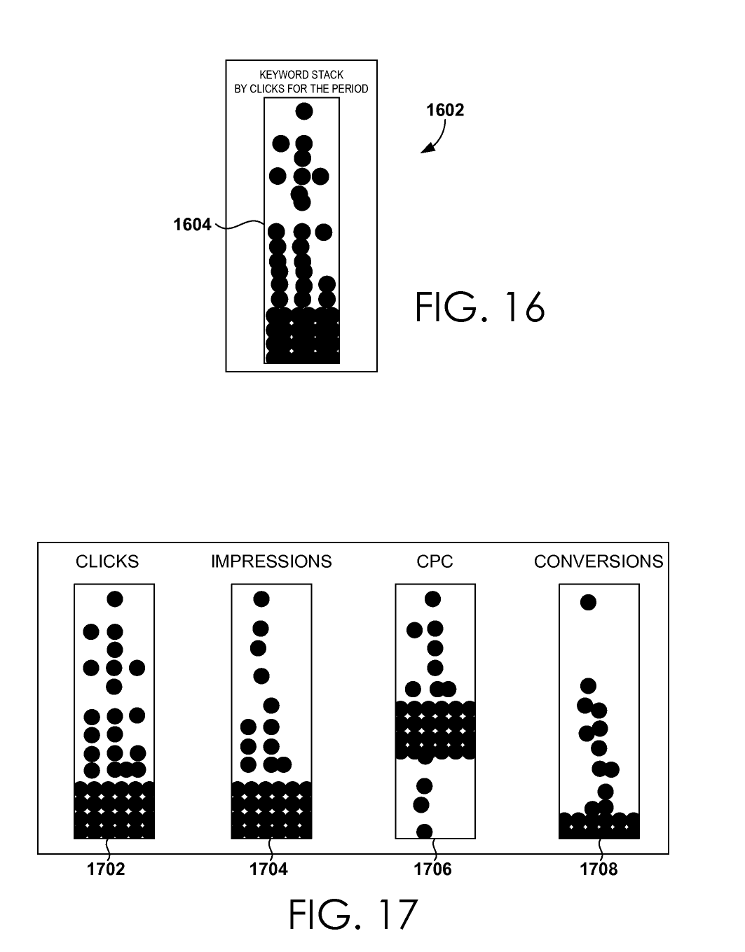

While FIGS. 3-15 illustrate a bar keyword stack implementation, such implementations and embodiments can be implemented along with other implementations, such as the dot implementation described in FIGS. 16-23.

FIGS. 16-24 illustrate various implementations pertaining to dot keyword stacks. As previously discussed, a keyword stack is used to visualize keyword distribution pertaining to an advertisement metric. With a dot implementation, each dot represents a keyword. FIG. 16 illustrates a keyword stack 1602 for a “click” metric. The keyword stacks shows all the keywords for an entire campaign or user account. The vertical scale is specific to keyword clicks for a specified time period. As such, the higher the position of a keyword representation, the higher the number of clicks associated therewith. If a keyword is positioned at the same horizontal level with another keyword representation, then the keywords have the same number of clicks or a same range of clicks. Accordingly, the dots are stacked on to one another to provide an overview of keyword distribution for the click metric. In FIG. 16, a user can quickly recognize many low-click keywords and that the highest click keywords are distantly trailed by a group of mid-range click keywords.

FIG. 17 illustrates a display of a multiple keyword stacks. As illustrated in FIG. 17, a keyword stack 1702 is illustrated for the clicks metrics, a keyword stack 1704 is illustrated for the impressions metric, a keyword stack 1706 is illustrated for the CPC metric, and a keyword stack 1708 is illustrated for the conversions metric. The shape of each stack is based on the metric and is unique from one another. For example, in the keyword stack 1706, most of the keywords have mid-range CPCs and only three keywords have really low CPC. By contrast, in the keyword stack 1708, a single keyword is positioned high above the other keywords indicating a standout keyword for conversions.

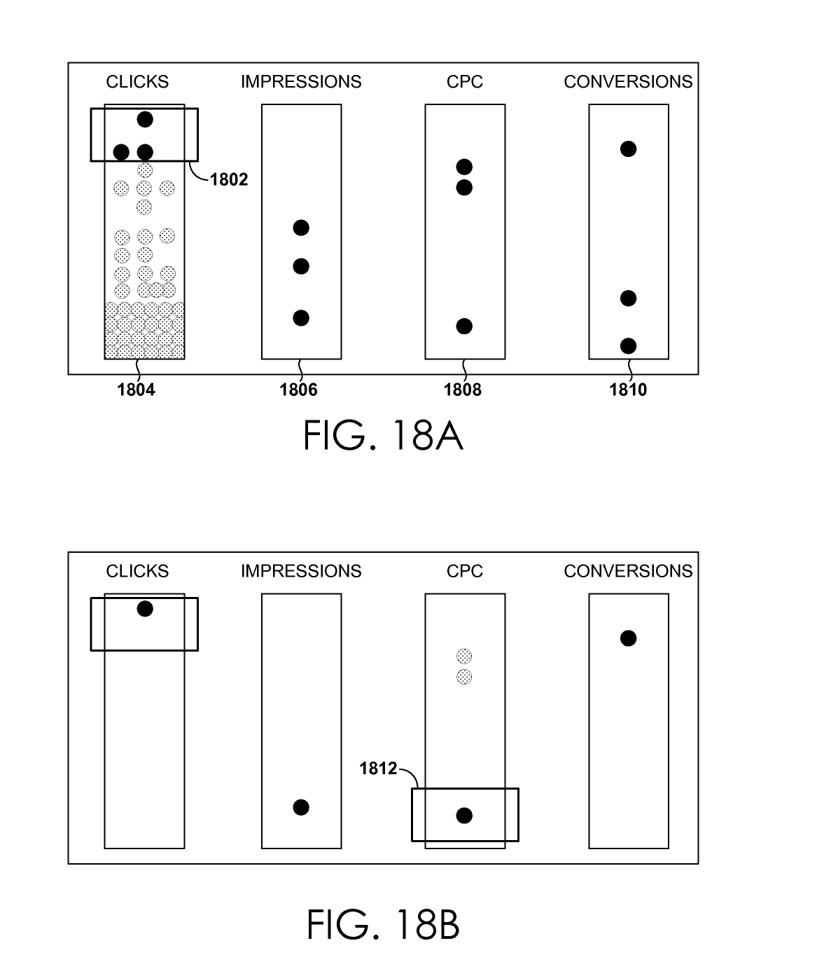

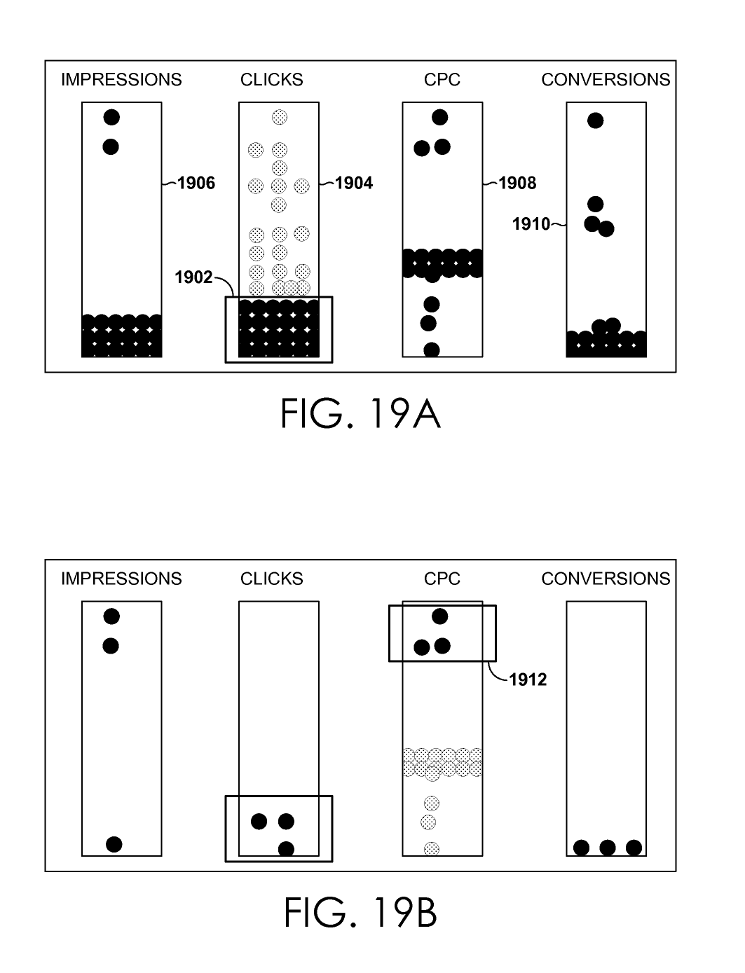

As with the bar keyword stacks illustrated above, the dot keyword stacks can be interacted with or filtered to narrow the focus to particular keyword representations. As illustrated in FIGS. 18A-18B, a user may select the top three keywords 1802 for the clicks metric in the keyword stack 1804. Based on such a filter, the keyword stacks 1806, 1808, and 1810 are automatically modified to display or visually distinguish the corresponding representations. As such, the user can quickly view how each of the keywords perform for various metrics. Now assume that the user recognizes that two of the remaining keywords have a high CPC value and one has a low CPC value. As the user may be interested in the keyword with the low CPC value, the user can select the keyword representation within the CPC stack to further filter the keyword data, as illustrated in FIG. 18B. Based on the selection of the keyword representation 1812, the user can recognize that the selected keyword also has high conversions and low impressions. As such, the user can instantly recognize that to achieve a higher return on investment, the user should increase the bid for this keyword.

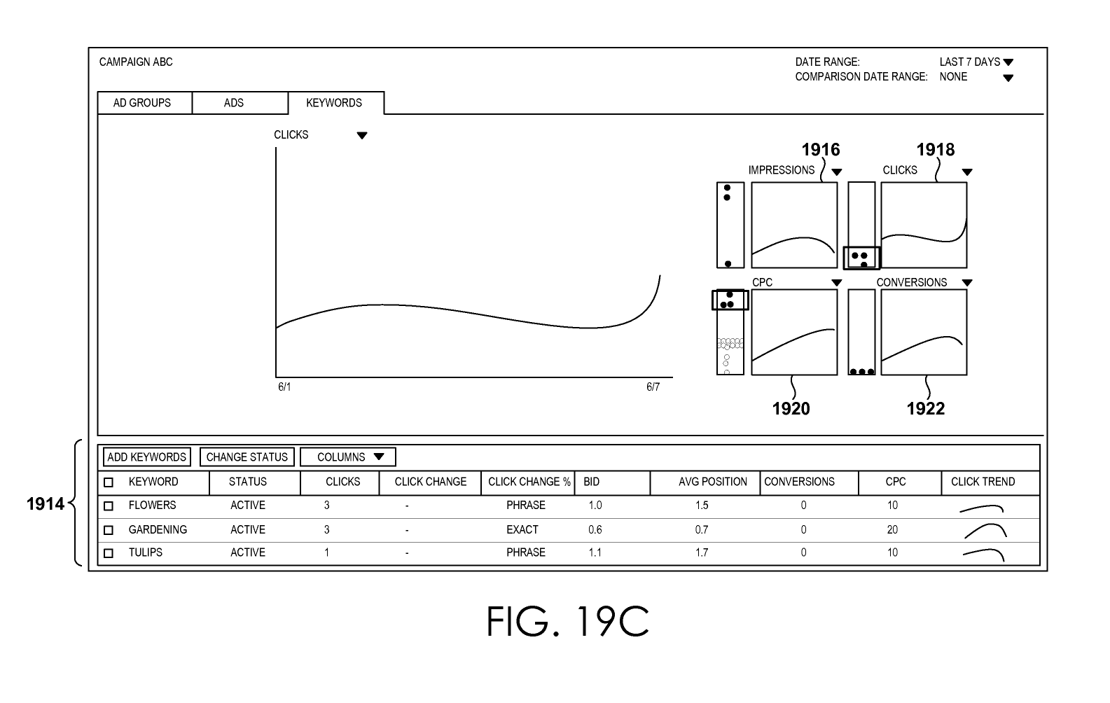

By way of another example and with reference to FIGS. 19A-19C, assume that the user in selects a group of tail keywords 1902 in FIG. 19A by selecting keywords with low positions in the clicks keyword stack 1904 resulting in a modification of the other keyword stacks 1906, 1908, and 1910 such that keyword stacks 1906, 1908, and 1910 display keyword representations corresponding with the selected keywords in keyword stack 1904. Now assume that the user selects three keyword representations 1912 with a high CPC cost, as illustrated in FIG. 19B. Accordingly, the user can view impressions, clicks, CPC, and conversions associated with the three keywords to recognize low-performing keywords with low clicks, high CPC and low conversions.

FIG. 19C illustrates interactions between the keyword stacks and a keyword grid and/or trending graphs. In this regard, the result of keyword stack selection or filtering is reflected in a keyword grid and/or trending graph(s). Assume that the three keywords representations illustrated in FIG. 19B remain. In such a case, the keyword grid can be filtered or narrowed to include the keywords and corresponding data. In some cases, the filtered-out keywords and corresponding data can be removed from the chart, moved to the bottom of the chart, or otherwise visually distinguished (e.g., faded, high-lighted, low-lighted, etc.). For example, as illustrated in FIG. 19C, the keyword grid 1914 may be filtered in accordance with any filter or multiple filters applied to one or more keyword stacks provided in the keyword stacks of FIG. 19B.

Further, trending graphs representing the metric trends can be provided, generated, or modified in accordance with the remaining keywords. For instance, an impressions trending graph 1916, a clicks trending graph 1918, a CPC trending graph 1920, and a conversions trending graph 1922 can be displayed with each such graph illustrating trends pertaining to the three selected keywords. As illustrated, keywords stacks can be positioned adjacent to or near the corresponding trending graphs.

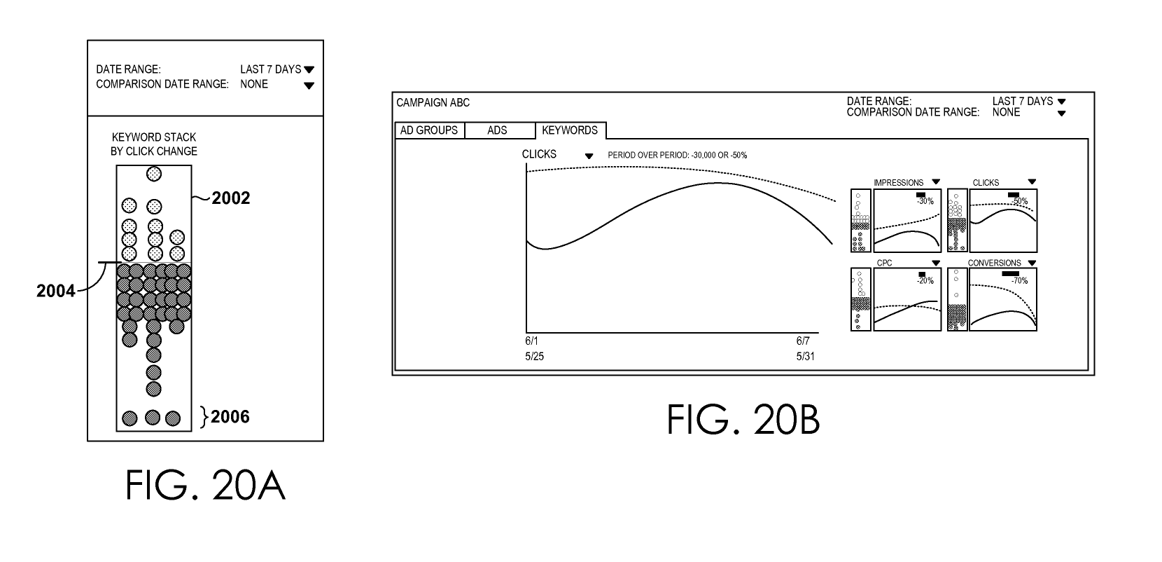

FIGS. 20A-20B illustrate keyword stacks using a period over period comparison. Accordingly, a keyword stack is based on metric changes over time. FIG. 20A illustrates a keyword stack that reflects period over period changes with respect to clicks. In particular, keyword stack 2002 illustrates a comparison of clicks of a current period (e.g., this month) to a prior period (e.g., last month). In such a keyword stack, each dot still represents a keyword. The vertical scale represents the click changes of a current period over a prior period. The dots displayed above the zero line 2004 reflect positive changes, and the dots displayed below the zero line 2004 reflect negative changes. The three keywords 2006 located at the bottom caused the most click decrease to the campaign period over period. FIG. 20B illustrates trending graphs representing the metric trends based on the period over period comparison. As illustrated in FIG. 20B, clicks decreased by 50% for the campaign as a whole. The keyword representations can be interacted with to select keywords of interest to the user.

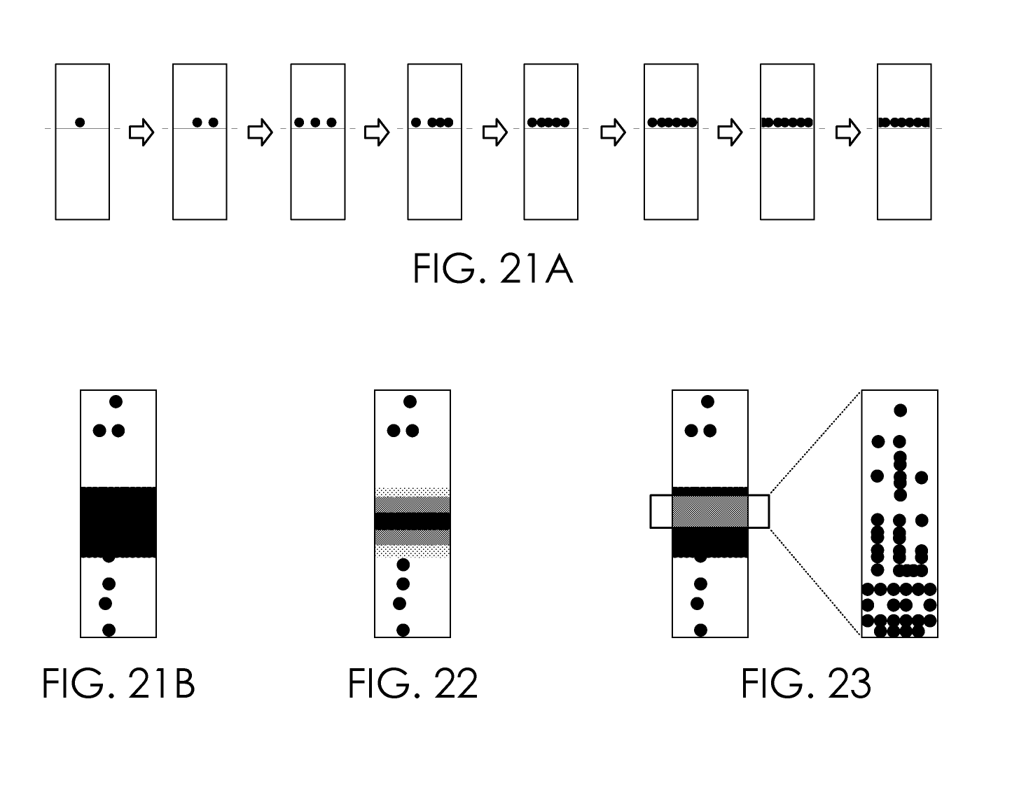

FIGS. 21-24 illustrate various implementations for illustrating density of keyword representations, for example, within a horizontal region when the keyword representations overlap. In a first implementation, keyword representations (e.g., dots) associated with a same value (or value range) on the vertical axis are plotted on the same horizontal stack level. To illustrate, assume a stack level can contain eight non-overlapping dots. The sequence of plotting the first eight dots at the same level is illustrated in FIG. 21A. After the stack level is fully occupied, additional keywords at that level will be applied on a second pass at the same level. Additional dots will overlap on top of the existing dots, as illustrated in FIG. 21B. In FIG. 22, a grey scale can be used to reflect the density for different stack levels. A darker shaded stack level can, for example, indicate a higher density of keywords. FIG. 23 zooms into a selected stack section and redraws the section to a new scale to provide more granular details on the section.

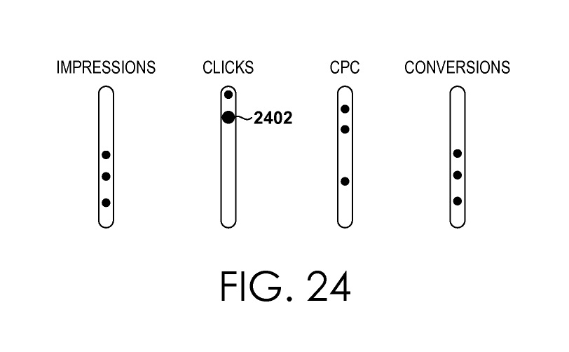

Dot keyword stacks can be any width. The width of the keyword stacks illustrated in FIGS. 16-23 are generally a width that can accommodate eight keyword representations (e.g., dots) juxtaposed to one another. The stacks, however, could be more narrow or wider than those illustrated in FIGS. 16-23. In one embodiment, the keyword stack might be a width to accommodate a single keyword representation. Such an embodiment is illustrated in FIG. 24. As multiple keyword representations accumulate for a particular vertical placement, the keyword representation expands, as illustrated at 2402. As such, at 2402, multiple keyword representations have the same number of clicks. The size of the dot may expand in accordance with the number of overlapping keywords.

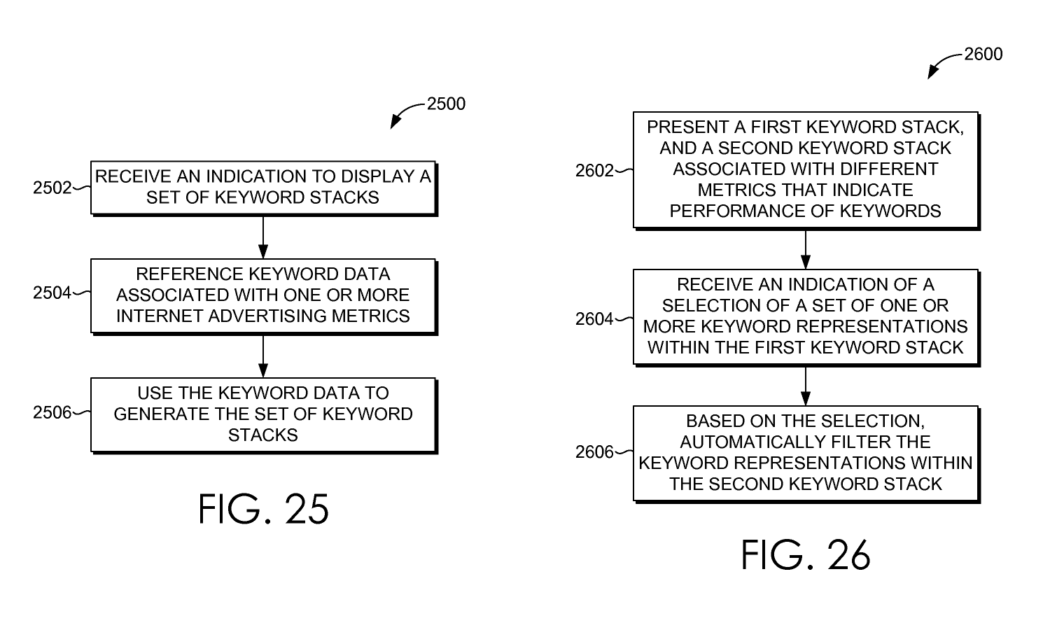

To recapitulate, embodiments of the invention include systems, machines, media, methods, techniques, processes and options for providing and filtering keyword stacks. Turning to FIG. 25, a flow diagram is illustrated that shows an exemplary method 2500 for presenting one or more keyword stacks, according to embodiments of the present invention. In some embodiments, aspects of embodiments of the illustrative method 2500 can be stored on computer-readable media as computer-executable instructions, which are executed by a process in a computing device, thereby causing the computing device to implement aspects of the method 2500. The same is, of course true, with the illustrative method 2600 depicted in FIG. 26, or any other embodiment, variation, or combination of these methods.

Initially, as indicated at block 2502, an indication to display a set of keyword stacks is received. In embodiments, each keyword stack is associated with a different internet advertising metric, such as, for example, a click, an impression, a spend, a conversion, an average position, an average cost per click, a click through rate, a cost per action, a cost per click, a conversion rate, or a percentage of change. Such an indication can be received automatically (e.g., upon a user viewing an advertising campaign or keyword analysis) or upon a user selection to display a particular type of keyword stack. At block 2504, keyword data associated with one or more internet advertising metrics is referenced. Such keyword data can, in embodiments, correspond with a designated, default, or selected time period. At block 2506, the keyword data is used to generate the set of keyword stacks. In some embodiments, each keyword stack is a bar keyword stack such that the stack includes a group of horizontal bars vertically stacked, with each horizontal bar representing a number of keywords falling within a particular metric measurement, or range thereof, corresponding with a vertical axis. In other embodiments, each keyword stack is a dot keyword stack such that a plurality of dots represent the keywords.

With reference now to FIG. 26, a flow diagram is illustrated that shows an exemplary method 2600 for filtering one or more keyword stacks, according to embodiments of the present invention. Initially, as indicated at block 2602, a first keyword stack and a second keyword stack are presented in association with a different keyword metric that indicates performance of keywords. In some embodiments, each of the stacks includes a representation of each keyword within an advertising campaign or an advertising account. Such keyword representations can be illustrated, for example, as dots or bars. At block 2604, an indication of a selection of a set of one or more keyword representations within the first keyword stack is received. For example, a user might select particular representations by hovering over and selecting such representations, utilizing sliders, utilizing a menu having various options, or the like. Thereafter, at block 2606, based on the selection, the keyword representations within the second keyword stack are automatically filtered. As such, the keyword representations within the second keyword stack are filtered to display or visually indicate the keyword representations that correspond with the selected keyword representations within the first keyword stack. Such filtered keyword representations can be distinguished in any manner, for example, by high-lighting, low-lighting, a modified font type, a modified color, or the like.

Although descriptions and illustrations provided herein generally pertain to the keyword stacks, embodiments of the present invention are not intended to be limited to keyword vertical stacks. Rather, stacks or vertical stacks can be generated in relation to various other concepts within the advertising campaign environment. For instance, vertical stacks can be generated in reference to, among others, search queries, advertisement units, placements, publishes, advertisements, advertisement groups, campaign groups, accounts, etc. Further, metric stack visualization can be applied and useful beyond the advertising industry. For example, in the financial industry, multi-metric stacks can assist users in visualizing individual stocks in a portfolio on the metrics of price changes, P/E ratio, volumes, etc. In another example for sales analysis for a book store, multi-metric stacks can assist in visualizing individual books on the metrics of price, sales volume, profit margin, and readership.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. A graphical user interface for displaying keyword stacks, stored on one or more computer-readable media and executable by a computing device, the graphical user interface comprising:
a keyword-stack display area configured to display one or more keyword stacks, each of the one or more keyword stacks associated with an internet advertising metric, wherein each keyword stack displays a keyword representation for each keyword within an advertising campaign with the keyword representation being vertically positioned in association with a corresponding value for the metric; and
a keyword grid display area configured to display a table of keywords and corresponding metric values for a plurality of metrics.

2. The graphical user interface of claim 1, wherein each of the one or more keyword stacks have a predefined width such that upon a specific number of keyword representations having a particular value being aligned across the width, additional keyword representations having the same value are overlapped over the aligned keyword representations.

3. The graphical user interface of claim 1 further comprising a time range selection area that enables a user to select a time period to associate with each of the one or more keyword stacks.

4. The graphical user interface of claim 1, wherein each of the internet advertising metric comprises a click, an impression, a spend, a conversion, an average position, an average cost per click, a click through rate, a cost per action, a cost per click, a conversion rate, or a percentage of change.

5. The graphical user interface of claim 1, wherein each of the keyword stacks can be filtered based on a user selection of one or more keyword representations.

6. The graphical user interface of claim 5, wherein filtering one of the keyword stacks based on the user selection of the one or more keyword representations automatically causes the other keyword stacks to be filtered in accordance with the selected keyword representations.

7. The graphical user interface of claim 5, wherein filtering one of the keyword stacks based on the user selection of the one or more keyword representations automatically causes filtering of the keywords within the keyword grid display area.

8. A computerized method, the method comprising:
receiving an indication to display a set of keyword stacks, each of the keyword stacks being associated with a different internet advertising metric;
referencing keyword data associated with each of the internet advertising metrics; and
using the keyword data associated with each of the internet advertising metrics to generate each of the keyword stacks, wherein each of the keyword stacks comprises a plurality of horizontal bars vertically stacked with each horizontal bar representing a number of keywords falling within a particular metric measurement, or range thereof, corresponding with a vertical axis.

9. The method of claim 8, wherein a longer or wider horizontal bar represents more keywords that fall into that metric measurement or range.

11. The method of claim 8, wherein the set of keyword stacks associated with the different internet advertising metrics to display are selected by a user.

12. The method of claim 8, wherein each of the different internet advertising metrics comprises one of a click, an impression, a spend, a conversion, an average position, an average cost per click, a click through rate, a cost per action, a cost per click, a conversion rate, or a percentage of change.

13. The method of claim 8 further comprising receiving an indication to filter one of the keyword stacks by selection of at least one of the horizontal bars within the one of the keyword stack.

14. The method of claim 13, wherein based on the indication to filter the one of the keyword stacks, automatically filtering the other keyword stacks within the set of keyword stacks.

15. The method of claim 14, wherein the other keyword stacks are filtered to visually indicate keywords associated with keywords represented in the at least one selected horizontal bar within the one of the keyword stack.

16. One or more computer-readable storage media having embodied thereon computer-executable instructions that, when executed by a processor in a computing device, cause the computing device to perform a method of filtering keyword representations, the media comprising:
presenting a first keyword stack and a second keyword stack, the first keyword stack and the second keyword stack associated with a different keyword metric that indicates performance of keywords, wherein each of the first keyword stack and the second keyword stack includes a representation of each keyword within an advertising campaign or an advertising account;
receiving an indication of a selection of a set of one or more keyword representations within the first keyword stack; and
based on the selection, automatically filtering keyword representations within the second keyword stack such that keyword representations within the second keyword stack that correspond with the selected one or more keyword representations within the first keyword stack are visually distinguished.

17. The media of claim 16 further comprising receiving an indication of a selection of a set of one or more keyword representations within the filtered second keyword stack.

18. The media of claim 17, wherein based on the selection of the set of the one or more keyword representations within the filtered second keyword stack, keyword representations within a third keyword stack are automatically filtered such that keyword representations within the third keyword stack that correspond with the selected one or more keyword representations within the filtered second keyword stack are visually distinguished.

19. The media of claim 16, wherein the keyword representations comprise dots provided with the first keyword stack and the second keyword stack.

20. The media of claim 16, wherein the keyword representations are provided by way of horizontal bars vertically stacked within the first keyword stack and the second keyword stack.
